(19) United States
(12) Patent Application Publication
(10) Pub. No.: US 2006/0203065 A1
(43) Pub. Date: Sep. 14, 2006

(54) Method for forming dots, method for forming identification code, and liquid ejection apparatus

(75) Inventors: Yuji Iwata, Suwa (JP); Hirotsuna Miura, Fujimi (JP); Hironori Hasei, Okaya (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/369,917

(22) Filed: Mar. 7, 2006

(30) Foreign Application Priority Data
Mar. 9, 2005 (JP) 2005-065688

(51) Int. Cl. B41J 2/01

(52) U.S. Cl. 347/102

(57) ABSTRACT

An acceptable duration is defined as the time necessary for allowing the diameter of a microdroplet that has reached the substrate to become a maximum acceptable droplet diameter. A scanning speed is set in such a manner that the microdroplet that has been received by the substrate reaches a radiating position from a droplet receiving position immediately after the acceptable duration has passed since reception of the microdroplet by the substrate. A laser beam is radiated onto the microdroplet immediately after the acceptable duration has passed since the reception of the microdroplet Fb by the substrate, or when the microdroplet is located at the radiating position.

### CROSS-REFERENCE TO RELATED APPLICATIONS

This application is based upon and claims the benefit f priority from prior Japanese Patent Application No. 2005-065688, filed on Mar. 9, 2005, the entire contents of which are incorporated herein by reference.

### BACKGROUND OF THE INVENTION

The present invention relates to methods for forming dots, methods for forming identification codes, and liquid ejection apparatuses.

Conventionally, electro-optic apparatuses such as liquid crystal displays and organic electroluminescence displays (organic EL displays) include transparent glass substrates (hereinafter, “substrates”) for displaying images. The substrates include identification codes (for example, two-dimensional codes) that indicate encoded information regarding the name of the manufacturer or the product number. One such identification code is formed by structures (dots defined by colored thin films or recesses) that reproduce the content of the encoded information. More specifically, the dots are provided in a number of dot formation areas (data cells) in accordance with a predetermined pattern.

In order to form an identification code, for example, Japanese Laid-Open Patent Publication No. 11-77340 and Japanese Laid-Open Patent Publication No. 2003-127537 disclose a laser sputtering method and a waterjet method, respectively. In the laser sputtering method, a code pattern is formed on a film through sputtering. In the waterjet method, a code pattern is formed in a substrate by ejecting water containing abrasive onto the substrate.

However, in the laser sputtering method, in order to form a dot a desired size, the distance between a metal thin film and the substrate must be set to several to several tens of micrometers. Thus, the opposing surfaces of the metal thin film and the substrate must be formed extremely flat and spaced from each other by a distance adjusted accurately in the order of micrometers. As a result, the laser sputtering method is applicable only to limited types of substrates, and cannot be used widely for general substrates. Further, in the waterjet method, water, dust, or abrasive is splashed onto the substrate when forming the code pattern, leading to contamination of the substrate.

To solve these problems, an inkjet method has been focused as an alternative method for forming identification codes. In the inkjet method, liquid droplets containing metal particles are ejected by a liquid ejection apparatus. The liquid droplets are then dried and thus the dot is provided. The inkjet method is thus applicable to a wider range of substrates. Further, the identification code is formed without contaminating the substrate.

However, when liquid droplets are dried on a substrate, the inkjet method may cause the following problems depending on the surface condition of the substrate or due to surface tension produced in the droplets. More specifically, when a droplet is received wet by the surface of the substrate, the droplet may spread beyond a specified data cell and enter an adjacent data cell. Further, if the surface tension of the liquid droplet is excessively great, the droplet may form a substantially spherical shape on the substrate. This may excessively reduce the ratio of the surface area of the droplet to that of the corresponding data cell. In this case, the code pattern cannot accurately reproduce the product information.

### SUMMARY OF THE INVENTION

It is an objective of the present invention to provide a method for forming dots, a method for forming an identification code, and a liquid droplet apparatus in which the dots are formed in accordance with a desired size.

To achieve the foregoing and other objectives and in accordance with the purpose of the present invention, a method for forming a dot by ejecting a liquid droplet onto a dot forming position defined on a substrate and drying the droplet that has reached the dot forming position is provided. A laser beam for drying the droplet is radiated onto the dot forming position.

The present invention also provides a method for forming an identification code pattern with a plurality of dots in a code formation area on a surface of a substrate. Data cells are formed by dividing the code formation area. The dots are formed in selected ones of the data cells by ejecting liquid droplets containing a dot forming material onto the selected data cells and drying the droplets in the selected data cells. A laser beams for drying the droplets are radiated onto the code formation area.

Further, the present invention provides a liquid ejection apparatus having pressurization means that pressurizes liquid retained in a pressure chamber and an ejection port through which a droplet of the liquid is ejected onto a dot forming position defined on a substrate through pressurization of the pressurization means. The apparatus includes laser radiation means, radiation control means, and a controller. The laser radiation means radiates a laser beam for drying the droplet that has been received by the substrate. When the ejected droplet is received by the substrate, the radiation control means operates the laser radiation means to radiate the laser beam onto the dot forming position when an outer diameter of the ejected droplet reaches a predetermined outer diameter. The controller controls operation of the radiation control means.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a liquid crystal display module;

FIG. 2 is a front view showing an identification code;

FIG. 3 is a side view showing the identification code;

FIG. 4 is a front view showing cells and dots that define the identification code;

FIG. 5 is a perspective view showing a liquid ejection apparatus according to an embodiment of the present invention;

FIG. 6 is a cross-sectional view showing the liquid ejection apparatus;

FIG. 7 is a perspective view showing an ejection head and a laser head;

FIG. 8 is a cross-sectional view showing portions of the ejection head and the laser head for explaining operation of the heads;

FIG. 9 is a block diagram showing the electrical configuration of the liquid ejection apparatus;

FIG. 10 is a timing chart representing operational timings of a piezoelectric element and a semiconductor laser;

FIG. 11 is a side view schematically showing a state of a microdroplet received by a substrate;

FIG. 12 is a side view schematically showing another state of the microdroplet received by the substrate;

FIG. 13 is a side view schematically showing another state of the microdroplet received by the substrate;

FIG. 14 is a graph representing changes in the diameter of the microdroplet as time elapses;

FIG. 15 is a cross-sectional view showing portions of an ejection head and a laser head according to a modified embodiment for explaining operation of the heads;

FIG. 16 is a cross-sectional view showing portions of an ejection head and a laser head according to a modified embodiment for explaining operation of the heads; and

FIG. 17 is a graph representing changes in the diameter of the microdroplet as time elapses.

### DETAILED DESCRIPTION OF THE PREFERRED EMBODIMENTS

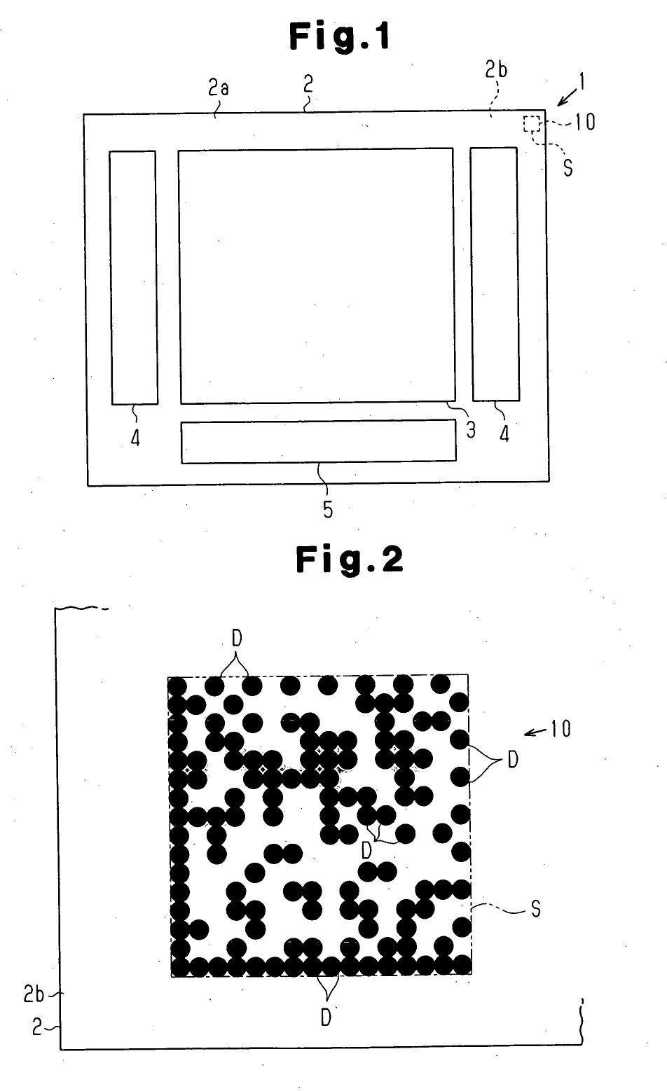

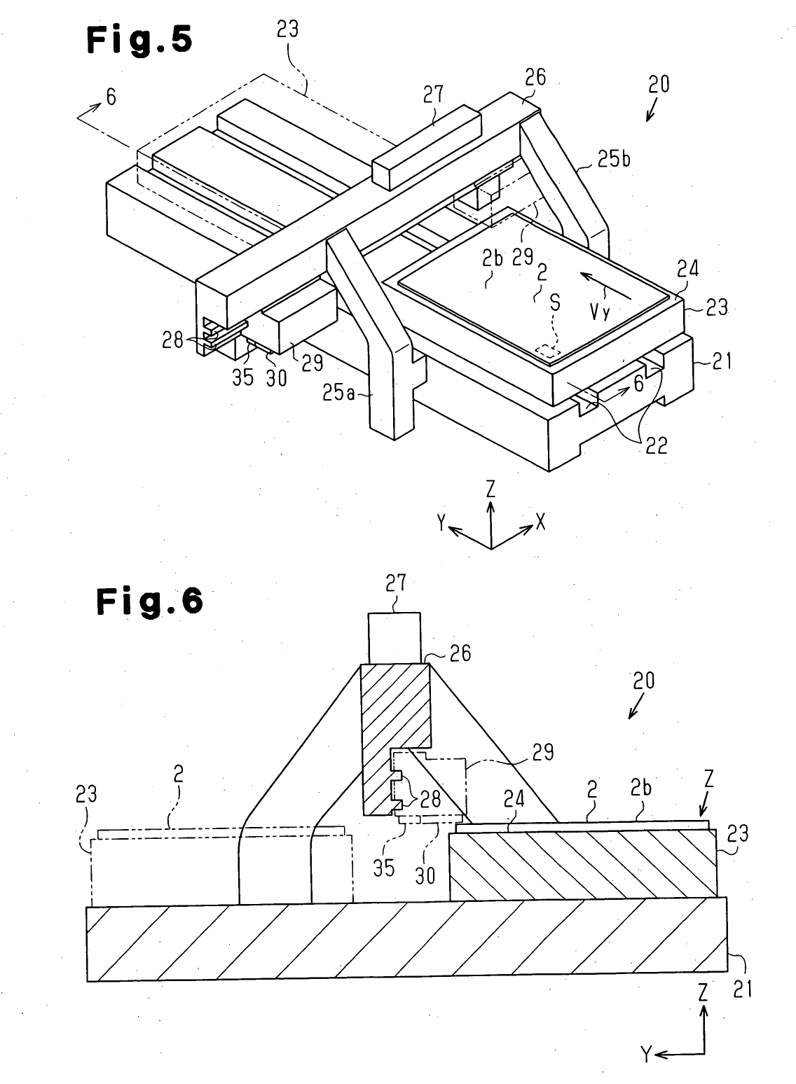

A method for forming an identification code on a display module of a liquid crystal display according to an embodiment of the present invention will now be described with reference to FIGS. 1 to 14. Directions X, Y, and Z in the following description are defined as indicated by the arrows of FIG. 5.

As shown in FIG. 1, a liquid crystal display module 1 includes a transparent glass substrate 2 (hereinafter, referred to as a substrate 2) serving as a light-transmittable display substrate. A rectangular display portion 3 is formed substantially in a center of a surface 2a of the substrate 2. Liquid crystal molecules are sealed in the display portion 3. A scanning line driver circuit 4 and a data line driver circuit 5 are arranged outside the display portion 3. The scanning line driver circuit 4 generates scanning signals and the data line driver circuit 5 generates data signals. Based on the signals, the liquid crystal display module 1 controls orientations of the liquid crystal molecules. The liquid crystal display module 1 modulates area light emitted by a non-illustrated illumination device in accordance with the orientation of the liquid crystal molecules. In this manner, an image is displayed on the display portion 3.

An identification code 10 of the liquid crystal display module 1 is formed on a backside 2b of the substrate 2, or a droplet receiving surface. Specifically, the identification code 10 is formed in a top right corner of the backside 2b as viewed in FIG. 1. Referring to FIG. 2, the identification code 10 is formed by a plurality of dots D. The dots D are provided in a code formation area S in accordance with a predetermined pattern.

As shown in FIG. 4, the code formation area S includes 256 data cells (hereinafter, cells C) aligned by 16 rows×16 columns. The cells C are provided by virtually dividing the code formation area S into uniform sections. More specifically, the code formation area S has a square shape each side of which is 1.12 millimeter long. Each of the cells C also has a square shape and the length of each side (a maximum acceptable droplet diameter Rmax) of the cell C is 70 micrometers. The identification code 10 of the liquid crystal display module 1 is defined by the dots D that are provided in selected ones of the cells C.

In the illustrated embodiment, each of the cells C in which a dot D is provided is defined as a black cell C1, or a dot forming position. Each of the empty cells C is defined as a blank cell C0. Referring to FIG. 4, the rows of the cells C are numbered from upward to downward, or from a first row, which is the uppermost row of the drawing, to a sixteenth row, the lowermost row, as viewed in the drawing. The columns of the cells C are numbered from the left to the right, or from a first column, which is the leftmost column, to a sixteenth column, or the rightmost column, as viewed in FIG. 4.

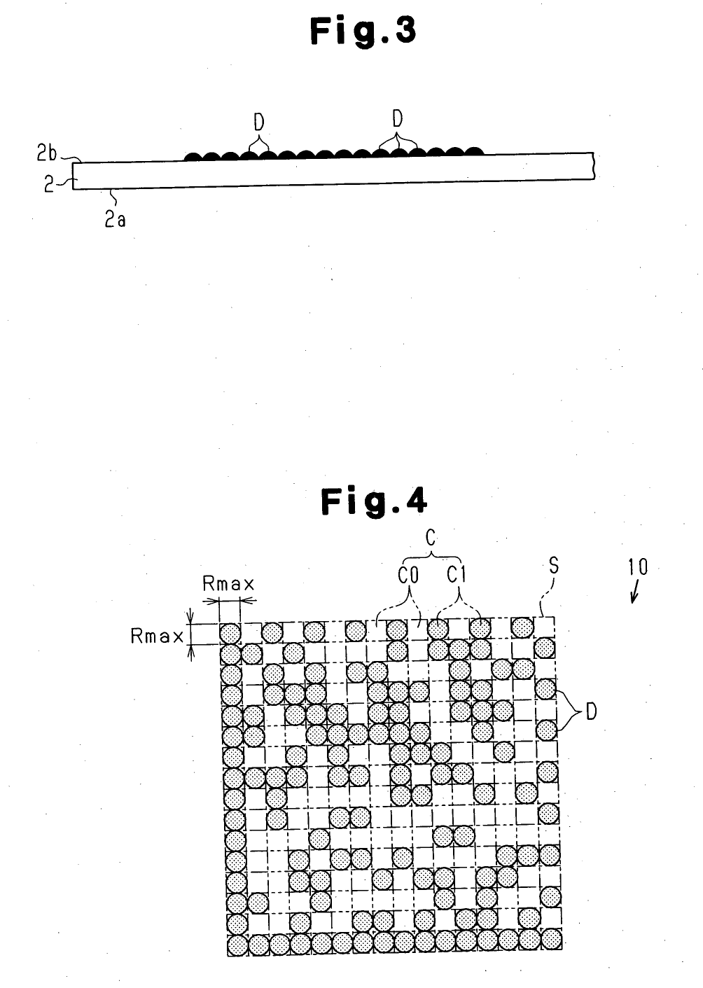

With reference to FIGS. 2 and 3, each of the dots D is securely bonded with the substrate 2 and has a semispherical shape as formed in the corresponding black cell C1. The dots D are provided by the inkjet method. More specifically, microdroplets Fb containing metal particles (for example, nickel particles) are ejected onto the cells C (the black cells C1) through an ejection nozzles N (hereinafter, referred to as nozzles N), which are an ejection ports defined in a liquid ejection apparatus 20 of FIG. 5. The microdroplets Fb are then dried in the cells C and the metal particles in the microdroplets Fb are sintered, thus forming the dots D. Such drying of the microdroplets Fb is performed by radiating a laser beam onto the microdroplets Fb that has been received by the substrate 2 (the corresponding black cells C1).

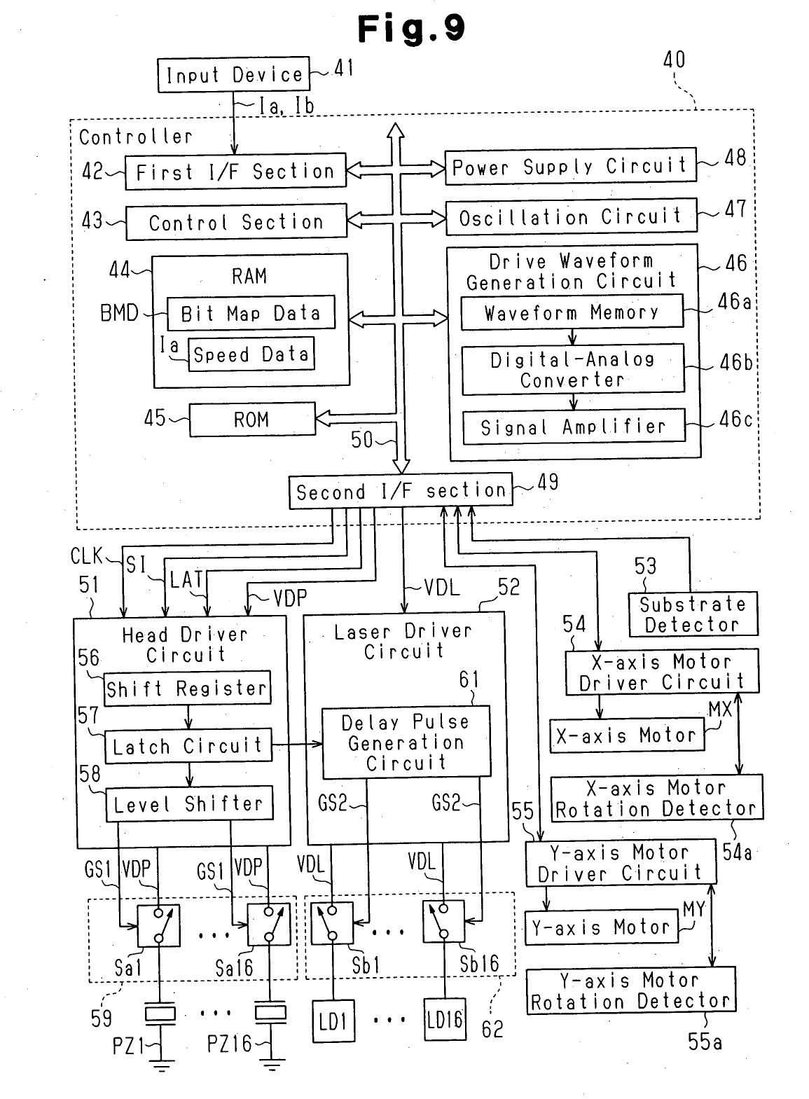

As shown in FIG. 5, the liquid ejection apparatus 20 includes a parallelepiped base 21. A pair of guide grooves 22 are defined in the upper surface of the base 21 and extend in direction Y. A substrate stage 23, or radiation control means, is secured to the upper surface of the base 21. The substrate stage 23 has a linear movement mechanism (not shown) formed by threaded shafts (drive shafts) extending along the guide grooves 22 and ball nuts engaged with the threaded shafts. The threaded shafts are connected to a y-axis motor MY (see FIG. 9), which is, for example a stepping motor. In response to a drive signal corresponding to a predetermined number of steps, the y-axis motor MY is rotated in a forward direction or a reverse direction. This reciprocates the substrate stage 23 at a predetermined speed along direction Y.

In the illustrated embodiment, the movement speed of the substrate stage 23 is defined as a scanning speed Vy. The position of the substrate stage 23 of FIG. 5 is defined as a first position. The position of the substrate stage 23 (indicated by the double-dotted broken lines) opposed to the first position is defined as a second position.

The upper surface of the substrate stage 23 forms a mounting surface 24 having a suction type substrate chuck mechanism (not shown). The substrate 2 is mounted on the mounting surface 24 with the backside 2b (the code formation area S) facing upward. In this state, the substrate chuck mechanism operates to position and fix the substrate 2 at a predetermined position on the mounting surface 24. More specifically, the substrate 2 is arranged on the mounting surface 24 in such a manner that the columns of the cells C extend along direction Y with the first row of the cells C located foremost in direction Y.

A pair of supports 25a, 25b are arranged at opposing sides of the base 21 and extend upward. A guide member 26 is secured to the upper ends of the supports 25a, 25b and extends along direction X. The longitudinal dimension of the guide member 26 is greater than the width of the substrate stage 23. An end of the guide member 26 projects outwardly with respect to the support 25a. A maintenance unit (not shown) for cleaning an ejection head 30 is deployed at a position immediately below the projecting end of the guide member 26.

A reservoir 27 is mounted on the upper side of the guide member 26 and retains liquid F (see FIG. 8). The liquid F is prepared by dispersing metal particles in a lyophilic dispersion medium. A pair of guide rails 28 are formed along the lower side of the guide member 26 and extend along direction X. A carriage 29 are movably supported by the guide rails 28 and includes a linear movement mechanism (not shown) formed by a threaded shaft (a drive shaft) and a ball nut. The threaded shaft of the mechanism extends along the guide rails 28 and the ball nut is engaged with the threaded shaft. The threaded shaft is connected to an x-axis motor MX (see FIG. 9). In response to a predetermined pulse signal, the x-axis motor MX is rotated in a forward direction or a reverse direction in accordance with a corresponding number of steps. In other words, when receiving a drive signal corresponding to a predetermined number of steps, the x-axis motor MX is rotated in the forward or reverse direction, thus reciprocating the carriage 29 along direction X.

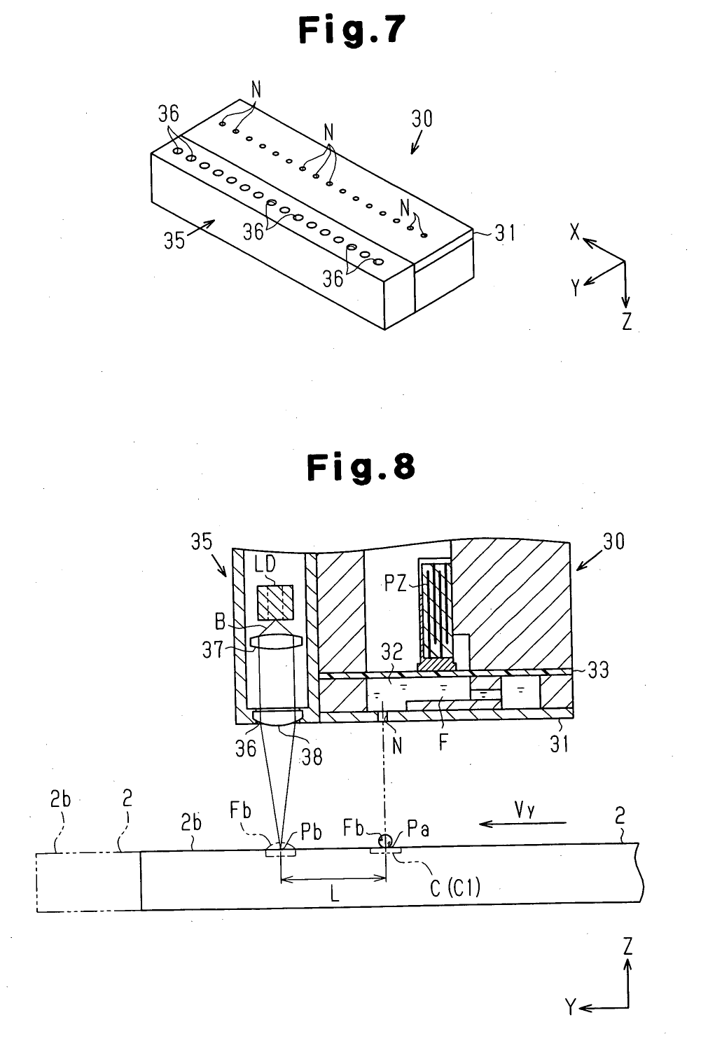

As shown in FIG. 6, the ejection head 30 is secured to a lower portion of the carriage 29. Referring to FIG. 7, a nozzle plate 31 is secured to a lower surface (an upper surface as viewed in the drawing) of the ejection head 30. Sixteen nozzles N are defined in the nozzle plate 31 for ejecting the microdroplets Fb (see FIG. 8). The nozzles N are aligned in a single row as equally spaced in direction X (in the direction defined by each row of the cells C).

Each of the nozzles N defines a circular hole and the pitch of the nozzles N is set to the pitch equal to that of the cells C. Each nozzle N extends in a direction defined by the thickness of the substrate 2 (the direction defined by the normal line Z of FIG. 7), which is mounted on the substrate stage 23. Thus, when the substrate 2 (the code formation area S) reciprocates along direction Y, the nozzle N opposes the cells C of the corresponding column.

As shown in FIG. 8, cavities 32, or pressure chambers, are defined in the ejection head 30. Each cavity 32 communicates with the reservoir 27 (FIG. 5). The liquid F is thus introduced from the reservoir 27 into each cavity 32 and then ejected through the corresponding one of the nozzles N. An oscillation plate 33 and a piezoelectric element PZ are provided above each cavity 32. When the ejection head 30 receives a drive signal for the piezoelectric elements PZ (a piezoelectric element drive voltage VDP), selected one of the piezoelectric elements PZ flexibly deform in a vertical direction. This causes the corresponding oscillation plates 33 to oscillate vertically and thus selectively increases or decreases the volume of the cavity 32. Accordingly, the liquid F is ejected onto positions immediately below the corresponding nozzles N through the nozzles N as the microdroplets Fb by an amount corresponding to the reduced volume of the corresponding cavities 32. In the illustrated embodiment, the positions at which ejection of the microdroplets Fb is aimed, or the positions on the substrate 2 immediately below the ink ejecting nozzles N, are defined as droplet receiving positions Pa.

As shown in FIG. 6, a laser head 35, or a laser radiating portion, is secured to a lower portion of the carriage 29 at a position adjacent to the ejection head 30. Referring to FIG. 7, sixteen radiation holes 36 are defined in the lower surface of the laser head 35 in correspondence with the nozzles N. With reference to FIG. 8, semiconductor lasers LD are provided in the laser head 35 as laser radiation means in correspondence with the radiation holes 36. When any one of the semiconductor lasers LD receives a drive signal (a laser drive voltage VDL) from a power supply circuit of FIG. 9, the semiconductor laser LD radiates a laser beam B through the corresponding radiation hole 36. The wavelength of the laser beam B is set to a value at which the dispersion medium of the microdroplets Fb can be dried (for example, 800 nanometers).

An optical system formed by a collimator 37 and a condenser lens 38 is arranged between each semiconductor laser LD and the corresponding radiation hole 36. The laser beam B is converted into a parallel light flux by the collimator 37 and reaches the condenser lens 38. The laser beam B is then sent to the substrate 2 through the condenser lens 38 and condensed at a position rearward from the droplet receiving position Pa. In this manner, a beam spot of a predetermined size is formed on the substrate 2 (the backside 2b).

In the illustrated embodiment, the position at which the laser beam B is condensed is defined as a radiating position Pb. The distance between the radiating position Pb and the droplet receiving position Pa is defined as an acceptable distance L. The acceptable distance is set to 20 nanometers in the illustrated embodiment. Further, in the embodiment, the beam diameter and the beam profile of the beam spot is set in such a manner as to form a substantially circular beam spot that covers a sufficient area of each cell C for uniformly drying the microdroplet Fb and exhibits a predetermined distribution of intensity. However, the beam diameter and the beam profile of such beam spot may be set in any other suitable manners different from this.

As the substrate stage 23 moves along direction Y (from the position indicated by the solid lines to the position indicated by the double-dotted broken lines of FIG. 8), each microdroplet Fb received by the substrate 2 at a droplet receiving position Pa moves to a radiating position Pb. More specifically, the microdroplet Fb moves from the droplet receiving position Pa to the radiating position Pb at the scanning speed Vy and in a predetermined time (acceptable duration Ta=L/Vy).

The electric configuration of the liquid ejection apparatus 20 will hereafter be explained with reference to FIG. 9.

As shown in FIG. 9, a controller 40 has a first I/F section 42, a control section 43 including a CPU, a RAM 44, and a ROM 45. The first I/F section 42 receives various data from an input device 41, which is formed by, for example, an external computer. The RAM 44 stores various data and the ROM 45 stores different control programs. The controller 40 also includes a drive waveform generation circuit 46, an oscillation circuit 47, the power supply circuit 48, and a second I/F section 49. The oscillation circuit 47 generates a clock signal CLK for synchronizing different drive signals. The power supply circuit 48 generates the laser drive voltage VDL for driving the semiconductor lasers LD. In the controller 40, the first I/F section 42, the control section 43, the RAM 44, the ROM 45, the drive waveform generation circuit 46, the oscillation circuit 47, the power supply circuit 48, and the second I/F section 49 are connected together through a bus 50.

The first I/F section 42 receives speed data Ia representing the scanning speed Vy and image forming data Ib representing an image of the identification code 10 from the input device 41. The identification code 10 is a two-dimensional code that is formed by a known method and indicates identification information including the product number and the lot number of the substrate 2.

The control section 43 stores the speed data Ia received by the first I/F section 42 in the RAM 44. In correspondence with the speed data Ia and the image forming data Ib, which have been received by the first I/F section 42, the control section 43 performs an identification code formation procedure. That is, the control section 43 executes a control program (for example, an identification code formation program) stored in the ROM 45 using the RAM 44 as a processing area. In accordance with the program, the control section 43 carries out a procedure for transporting the substrate 2 by moving the substrate stage 23 and a droplet ejection procedure by actuating the piezoelectric elements PZ of the ejection head 30. Further, in accordance with the identification code formation program, the control section 43 drives the semiconductor lasers LD and thus performs a drying procedure for drying the microdroplets Fb.

More specifically, the control section 43 performs a predetermined development procedure on the image forming data Ib received by the first I/F section 42. This produces bit map data BMD that indicates whether or not the microdroplets Fb must be ejected onto the cells C that are defined on a two-dimensional image forming plane (the pattern formation area S). The bit map data BMD is then stored in the RAM 44. The bit map data BMD is formed by serial data that has a bit length of 16×16 bits in correspondence with the piezoelectric elements PZ. That is, in accordance with the value (0 or 1) of each bit, the corresponding piezoelectric element PZ is turned on or off.

The control section 43 performs an additional development procedure, which is different from the development procedure corresponding to the bit map data BMD, on the image forming data Ib. This produces waveform data for the piezoelectric element drive voltage VDP that is supplied to each of the piezoelectric elements PZ. The waveform data is then output to the drive waveform generation circuit 46. The drive waveform generation circuit 46 has a waveform memory 46a, a digital-analog converter section 46b, and a signal amplifier 46c. The waveform memory 46a stores the waveform data. The digital-analog converter section 46b converts the waveform data into an analog signal. The signal amplifier 46c amplifies the analog signal. Thus, the drive waveform generation circuit 46 converts the waveform data stored in the waveform memory 46a into the analog signal by means of the digital-analog converter section 46b. The analog signal is then amplified by the signal amplifier 46c and thus the piezoelectric element drive voltage VDP is generated.

The control section 43 serially transmits an ejection control signal SI to a head driver circuit 51 through the second I/F section 49. The ejection control signal SI is produced by synchronizing the bit map data BMD with the clock signal CLK generated by the oscillation circuit 47. The control section 43 also sends a latch signal LAT to the head driver circuit 51 for latching the ejection control signal SI. Further, the control section 43 outputs the piezoelectric element drive voltage VDP to the head driver circuit 51 synchronously with the clock signal CLK.

The head driver circuit 51, a laser driver circuit 52 forming radiation control means, a substrate detector 53, an x-axis motor driver circuit 54, and a y-axis motor driver circuit 55 are connected to the controller 40 via the second I/F section 49.

The head driver circuit 51 has a shift register 56, a latch circuit 57, a level shifter 58, and a switch circuit 59. The shift register 56 performs serial-parallel conversion on the ejection control signal SI, which is transferred from the controller 40 (the control section 43), in correspondence with the sixteen piezoelectric elements PZ (PZ1 to PZ16). The latch circuit 57 latches the ejection control signal SI of 16 bits that has been converted into a parallel signal, synchronously with the latch signal LAT. The latched ejection control signal SI is then output to the level shifter 58 and the laser driver circuit 52. The level shifter 58 raises the voltage of the ejection control signal SI to the drive voltage of the switch circuit 59. In this manner, an open-close signal GS1 is generated in correspondence with each of the piezoelectric elements PZ. The switch circuit 59 includes switch elements Sa1 to Sa16 in correspondence with the piezoelectric elements PZ. The common piezoelectric drive voltage VDP is input to the input of each switch element Sa1 to Sa16. The output of each switch element Sa1 to Sa16 is connected to the corresponding one of the piezoelectric elements PZ (PZ1 to PZ16). Each switch element Sa1 to Sa16 receives the corresponding open-close signal GS1 from the level shifter 58. In correspondence with the open-close signal GS1, it is determined whether or not the piezoelectric element drive voltage VDP should be supplied to the piezoelectric element PZ.

In the illustrated embodiment, the common piezoelectric drive voltage VDP is supplied to the piezoelectric elements PZ through the corresponding switch elements Sa1 to Sa16. Further, operation of each switch element Sa1 to Sa16 is controlled based on the ejection control signal SI (the open-close signal GS1). When the switch element Sa1 to Sa16 is closed, the piezoelectric drive voltage VDP is supplied to the corresponding piezoelectric element PZ1 to PZ16. The microdroplet Fb is thus ejected from the nozzle N corresponding to the piezoelectric element PZ1 to PZ16.

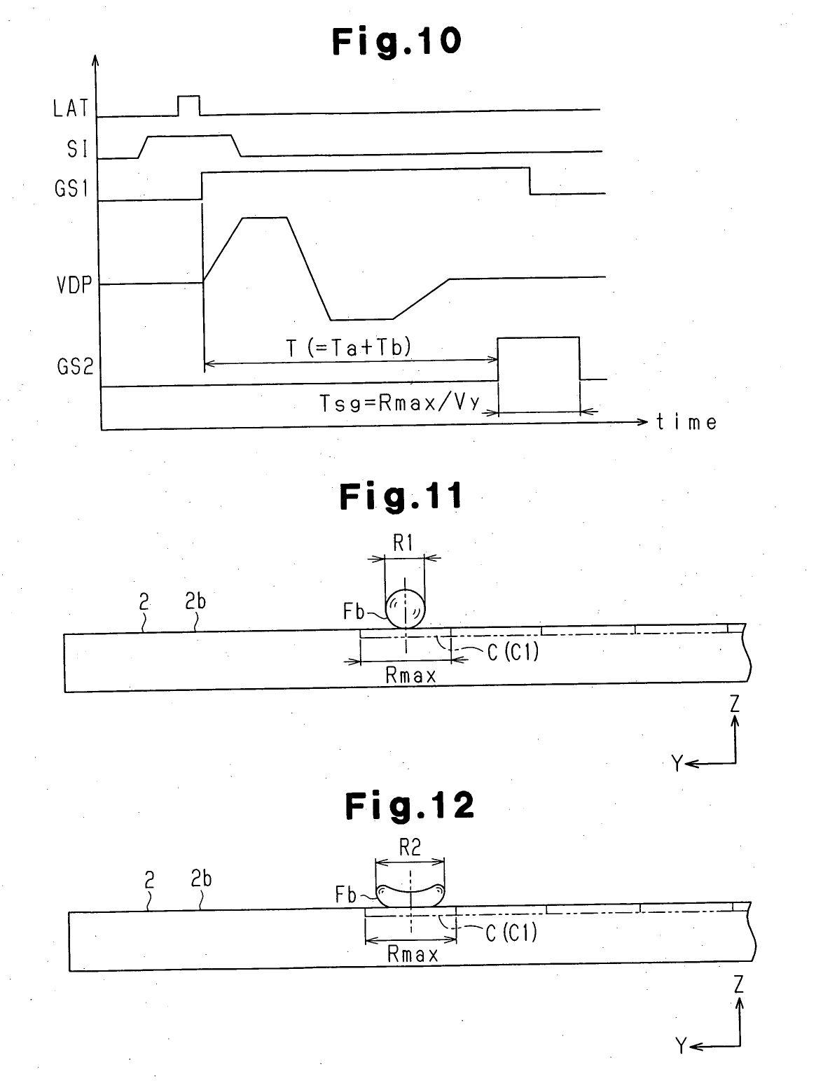

FIG. 10 shows the pulse waveforms of the latch signal LAT, the ejection control signal SI, and the open-close signal GS1 and the waveform of the piezoelectric drive voltage VDP, which is supplied to the corresponding piezoelectric element PZ in response to the open-close signal GS1.

As shown in FIG. 10, after the rise of the latch signal LAT, the open-close signal GS1 is produced based on the 16-bit ejection control signal SI. At the rise of the open-close signal GS1, the piezoelectric element PZ corresponding to the open-close signal GS1 is supplied with the piezoelectric element drive voltage VDP. As the piezoelectric element drive voltage VDP increases, the piezoelectric element PZ contracts. The liquid F is thus introduced into the cavity 32. Subsequently, as the piezoelectric element drive voltage VDP decreases, the piezoelectric element PZ expands. This causes the liquid F to flow from the cavity 32 and thus be ejected from the corresponding nozzle Z as the microdroplet Fb. The piezoelectric element drive voltage VDP then restores the initial value, thus completing the ejection of the microdroplet Fb.

As shown in FIG. 9, the laser driver circuit 52 has a delay pulse generation circuit 61 and a switch circuit 62. The delay pulse generation circuit 61 generates a pulse signal (an open-close signal GS2) by delaying the latched ejection control signal SI by a predetermined time (standby time T). The open-close signal GS2 is then output to the switch circuit 62. The standby time T (T=Ta+Tb) is determined by adding the time (ejection time Tb) from when the ejection is started by the piezoelectric element PZ (when the piezoelectric element drive voltage VDP is turned on) to when the microdroplet Fb is received by the substrate 2 to the acceptable duration Ta (Ta=L/Vy).

The switch circuit 62 includes switch elements Sb1 to Sb16 in correspondence with the semiconductor lasers LD. The common laser drive voltage VDL is input to the input of each switch element Sb1 to Sb16. The output of the switch element Sb1 to Sb16 is connected to the corresponding semiconductor laser LD (LD1 to LD16). Each switch element Sb1 to Sb16 receives the corresponding open-close signal GS2 from the delay pulse generation circuit 61. In correspondence with the open-close signal GS2, it is determined whether the laser drive voltage VDL should be supplied to the semiconductor laser LD.

In this manner, the liquid ejection apparatus 20 supplies the laser drive voltage VDL generated by the power supply circuit 48 commonly to the semiconductor lasers LD through the corresponding switch elements Sb1 to Sb16. Further, operation of each of the switch elements Sb1 to Sb16 is controlled in correspondence with the ejection control signal SI (the open-close signal GS2) provided by the controller 40 (the control section 43). When the switch element Sb1 to Sb16 is closed, the corresponding semiconductor laser LD1 to LD16 is supplied with the laser drive voltage VDL and thus radiates the laser beam B.

Referring to FIG. 10, the pulse-time width of the open-close signal GS2 is set to the time necessary for passing the single one of the cells C through the laser beam B (the beam spot), and the following equation is satisfied: the pulse-time width Tsg=Rmax/Vy. The open-close signal GS2 is generated after the standby time T (T=acceptable duration Ta+flying time Tb) has elapsed since inputting of the latch signal LAT to the head driver circuit 51. When the open-close signal GS2 is turned on, the laser drive voltage VDL is supplied to the corresponding semiconductor laser LD. This causes the semiconductor laser LD to radiate the laser beam B. Then, after the pulse-time width Tsg has elapsed since entering of the cell C in the spot of the laser beam B, the open-close signal GS2 is turned off. This stops the supply of the laser drive voltage VDL and thus ends a drying procedure by the semiconductor laser LD.

The controller 40 is connected to the substrate detector 53 through the second I/F section 49. The controller 40 detects an end of the substrate 2 by means of the substrate detector 53. In correspondence with such detection, the controller 40 calculates the position of the substrate 2 passing immediately below the ejection head 30 (the nozzle N) (see FIG. 6).

The controller 40 is connected to the x-axis motor driver circuit 54 via the second I/F section 49. The controller 40 sends an x-axis motor drive signal to the x-axis motor driver circuit 54. In response to the x-axis motor drive signal, the x-axis motor driver circuit 54 generates a signal for rotating the x-axis motor MX in the forward or reverse direction. Through such rotation of the x-axis motor MX, the carriage 29 is reciprocated along direction X at a predetermined speed.

The controller 40 is connected to an x-axis motor rotation detector 54a through the x-axis motor driver circuit 54. In response to a detection signal of the x-axis motor rotation detector 54a, the controller 40 detects the rotational direction and the rotational amount of the x-axis motor MX. Based on such detection, the controller 40 calculates the movement direction and the movement amount of the carriage 29.

The controller 40 is connected to the y-axis motor driver circuit 55 via the second I/F section 49. The controller 40 sends a y-axis motor drive signal to the y-axis motor driver circuit 55, with reference to the speed data Ia stored in the RAM 44. In response to the y-axis motor drive signal, the y-axis motor driver circuit 55 generates a signal for rotating the y-axis motor MY in the forward or reverse direction. Through such rotation of the y-axis motor MY, the substrate stage 23 is reciprocated along direction Y at the scanning speed Vy.

The controller 40 is connected to a y-axis motor rotation detector 55a through the y-axis motor driver circuit 55. Based on a detection signal of the y-axis motor rotation detector 55a, the controller 40 detects the rotational direction and the rotational amount of the y-axis motor MY. Based on such detection, the controller 40 calculates the movement direction and the movement amount of the substrate stage 23.

A method for setting the scanning speed Vy will be described in the following.

Using an ultra-high speed camera, the inventor of the present invention has observed change of the shape of the microdroplet Fb on the substrate 2 and measured the time needed for the outer diameter of the microdroplet Fb (the droplet diameter) to reach the value corresponding to the length of each side of the cell C (the maximum acceptable droplet diameter Rmax). As a result, it has been found that the dot D can be prevented from spreading beyond the corresponding cell C (the corresponding black cell C1) by setting the time (the acceptable duration Ta) from when the microdroplet Fb is received by the cell C to when radiation of the laser beam B is started to a value not more than the aforementioned measured time.

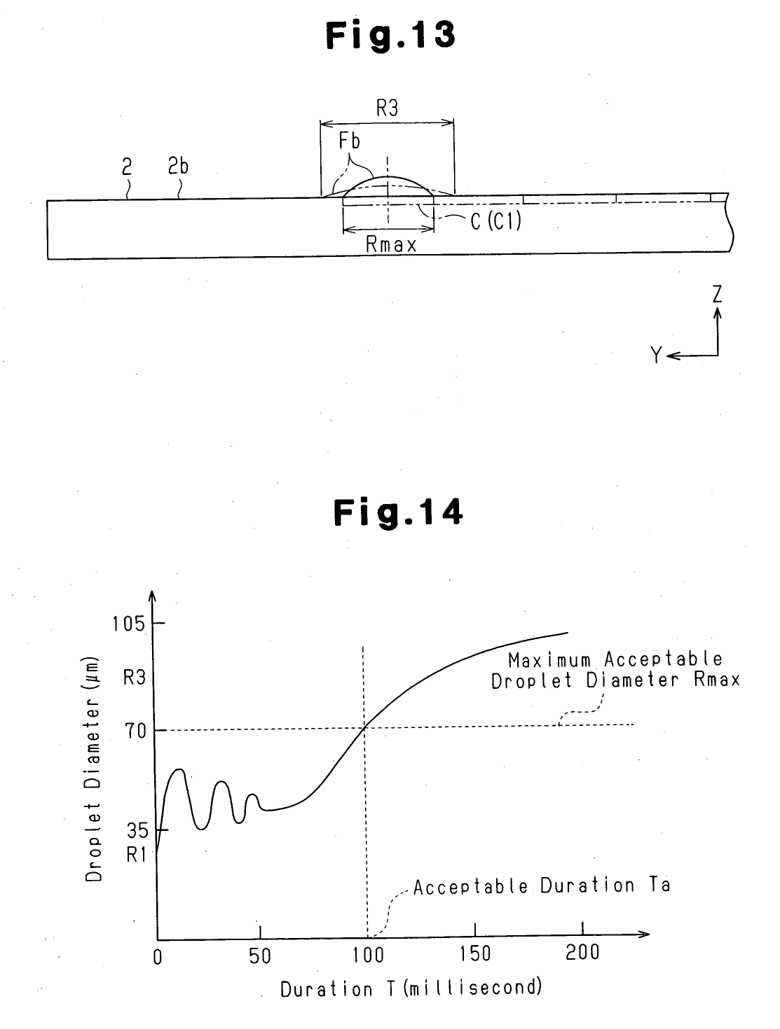

More specifically, as shown in FIG. 11, the microdroplet Fb having a substantially spherical shape was ejected onto the substrate 2. The diameter of the microdroplet Fb (the droplet diameter R1) corresponded to substantially half the length of each side of each cell C (the maximum acceptable droplet diameter Rmax). Referring to FIG. 12, the microdroplet Fb spread on the backside 2b of the substrate 2 in a disk-like shape. More specifically, the microdroplet Fb continuously spread until the outer diameter of the microdroplet Fb reached a droplet diameter R2. From this point, the microdroplet Fb repeatedly contracted and expanded on the backside 2b of the substrate 2. Such deformation of the microdroplet Fb was then stopped on the backside 2b in a spreading state defining a substantially semispherical shape and in a wet state, with reference to FIG. 13, due to the lyophilic property of the substrate 2. At this stage, the outer diameter of the microdroplet Fb (a droplet diameter R3) was greater than the maximum acceptable droplet diameter Rmax. Referring to FIG. 14, in approximately 50 milliseconds after the microdroplet Fb was received by the substrate 2, the outer diameter of the microdroplet Fb gradually increased from the original diameter (the droplet diameter R1) while fluctuating. It was made clear that the outer diameter of the microdroplet Fb exceeded the maximum acceptable droplet diameter Rmax (which is, in the illustrated embodiment, 70 micrometers) after 100 milliseconds elapsed since the microdroplet Fb was received by the substrate 2.

It is thus indicated that, if the acceptable duration Ta is set to a value not more than 100 milliseconds and the microdroplet Fb reaches the radiating position Pb immediately after the acceptable duration Ta, the dot D can be prevented from spreading beyond the corresponding cell C (the corresponding black cell C1). In other words, the dot D can be contained in the cell C (the black cell C1) by setting the scanning speed Vy of the substrate stage 23 (Vy=L/Ta) to a value not less than 20 millimeters in 100 milliseconds (=200 millimeters per second).

In the illustrated embodiment, the scanning speed Vy is set to a value that prevents the dot D from spreading beyond the corresponding cell C (the corresponding black cell C1) and maximizes the outer diameter of the dot D, or 200 millimeters per second. However, the acceptable duration Ta and the scanning speed Vy may differ depending on the wettability of the microdroplet Fb relative to the substrate 2, the maximum acceptable droplet diameter Rmax, and the ejection amount of the microdroplet Fb (the droplet diameter R1). The scanning speed Vy thus may be set to a different value than the value of the embodiment.

A method for forming the identification code 10 will hereafter be explained.

First, as shown in FIG. 5, the substrate 2 is mounted on and fixed to the substrate stage 23 with the backside 2b facing upward. In this state, an end of the substrate 2 that faces in direction Y is located rearward in direction Y relative to the guide member 26. The carriage 29 is set in such a manner that the identification code 10 (the code formation area S) passes immediately below the ejection head 30 when the substrate 2 moves along direction Y.

The controller 40 then operates the y-axis motor MY to transport the substrate 2 as mounted on the substrate stage 23 at the scanning speed Vy. When the substrate detector 53 detects the end of the substrate 2 facing in direction Y, the controller 40 determines whether the first row of the cells C (the black cells C) has reached the droplet receiving position Pa, based on the detection signal of the y-axis motor rotation detector 55a.

At this stage, the controller 40 outputs the ejection control signal SI and the piezoelectric element drive voltage VDP to the head driver circuit 51 in accordance with the code forming program. The controller 40 also outputs the laser drive voltage VDL to the laser driver circuit 52. The controller 40 then stands by till the latch signal LAT is sent.

When the first row of the cells C (the black cells C1) reaches the droplet receiving position Pa, the controller 40 provides the latch signal LAT to the head driver circuit 51. In response to the latch signal LAT, the head driver circuit 51 generates the open-close signal GS1 based on the ejection control signal SI. The open-close signal GS1 is then sent to the switch circuit 59. Further, the head driver circuit 51 supplies the piezoelectric element drive voltage VDP to each of the piezoelectric elements PZ corresponding to the switch elements Sa1 to Sa16 that are held in a closed state. This causes the microdroplets Fb to be simultaneously ejected from the corresponding nozzles N.

When the head driver circuit 51 receives the latch signal LAT, the laser driver circuit 52 (the delay pulse generation circuit 61) receives the latched ejection control signal SI and thus starts generation of the open-close signal SG2. The laser driver circuit 52 then stands by till the open-close signal GS2 is sent to the switch circuit 62.

Meanwhile, the controller 40 operates to transport the substrate 2 in direction Y at the scanning speed Vy. In this manner, each microdroplet Fb that has been received by the corresponding black cell C1 is moved from the droplet receiving position Pa to the radiating position Pb. Such movement of the microdroplet Fb is completed after the acceptable duration Ta (Ta=L/Vy) has elapsed since reception of the microdroplet Fb by the black cell C1, or, after the standby time T (T=Ta+Tb) has elapsed since starting of the ejection by the corresponding piezoelectric element PZ.

With the microdroplet Fb maintained at the radiating position Pb, the laser driver circuit 52 sends the open-close signal GS2 to the switch circuit 62. Further, the laser driver circuit 52 supplies the laser drive voltage VDL to the semiconductor lasers LD corresponding to the switch elements SB1 to Sb16 that are held in the closed states. As a result, the laser beams B are radiated simultaneously from the corresponding semiconductor lasers LD.

In this manner, after the acceptable duration Ta has elapsed, each of the microdroplets Fb received by the corresponding black cells C1 of the first row is irradiated with the laser beam B from the corresponding semiconductor laser LD. This causes the dispersion medium of each microdroplet Fb to evaporate and thus dry the microdroplet Fb. Accordingly, the microdroplet Fb is fixed to the backside 2b of the substrate 2. That is, the dots D corresponding to the first row of the cells C (the black cells C1) are provided as contained in the corresponding cells C.

Afterwards, the controller 40 continuously transports the substrate 2 at the scanning speed Vy in the same manner as has been described for the first row of the cells C. When a subsequent row of the cells C reaches the droplet receiving position Pa, the controller 40 operates to eject the microdroplets Fb collectively from the nozzles N corresponding to the black cells C1 of the row. Then, after the acceptable duration Ta has elapsed since reception of the microdroplets Fb by the substrate 2, the laser beams B are collectively radiated onto the microdroplets Fb held on the substrate 2.

When all of the dots D that define the identification code 10 are completed, the controller 40 operates the y-axis motor MY to retreat the substrate 2 from the position below the ejection head 30.

The illustrated embodiment has the following advantages.

(1) The time from when each microdroplet Fb reaches the substrate 2 to when the diameter of the microdroplet Fb becomes the maximum acceptable droplet diameter Rmax is defined as the acceptable duration Ta. Further, in the acceptable duration Ta following reception of the microdroplet Fb by the substrate 2, the microdroplet Fb is transported to the radiating position Pb at the scanning speed Vy. In other words, immediately after the acceptable duration Ta has elapsed, or when the microdroplet Fb is located at the radiating position Pb, the laser beam B is radiated onto the microdroplet Fb. This prevents the microdroplet Fb from becoming dry in a state spreading beyond the corresponding cell C (the corresponding black cell C1). The dot D is thus formed with the outer diameter of the microdroplet Fb maintained as the maximum size of the cell C (the maximum acceptable droplet diameter Rmax).

(2) In response to the ejection control signal SI, the open-close signal GS1 is generated in correspondence with each of the switch elements Sa1 to Sa16 and the open-close signal GS2 is produced in correspondence with each of the switch elements Sb1 to Sb16. The open-close signal GS2 rises after the standby time T has elapsed since rising of the open-close signal GS1. In this manner, the laser beam B is reliably radiated only to the cell C containing the microdroplet Fb. Also, each dot D is formed reliably with the outer diameter of the microdroplet Fb set to the maximum acceptable droplet diameter Rmax.

(3) The radiating position Pb can be spaced from the droplet receiving position Pa by an amount corresponding to the distance for which the microdroplet Fb is moved at the scanning speed Vy. This arrangement allows the laser head 35 to be deployed at a desired position. Further, the intensity and the profile of radiation of the laser beam B are selected as desired. That is, the radiation of the laser beam B can be performed in correspondence with the drying temperature of the microdroplet Fb (the dispersing medium) and the beam profile. Thus, the microdroplet Fb is dried uniformly and the corresponding dot D is formed further reliably with the outer diameter of the microdroplet Fb set to the maximum acceptable droplet diameter Rmax.

The illustrated embodiment may be modified as follows.

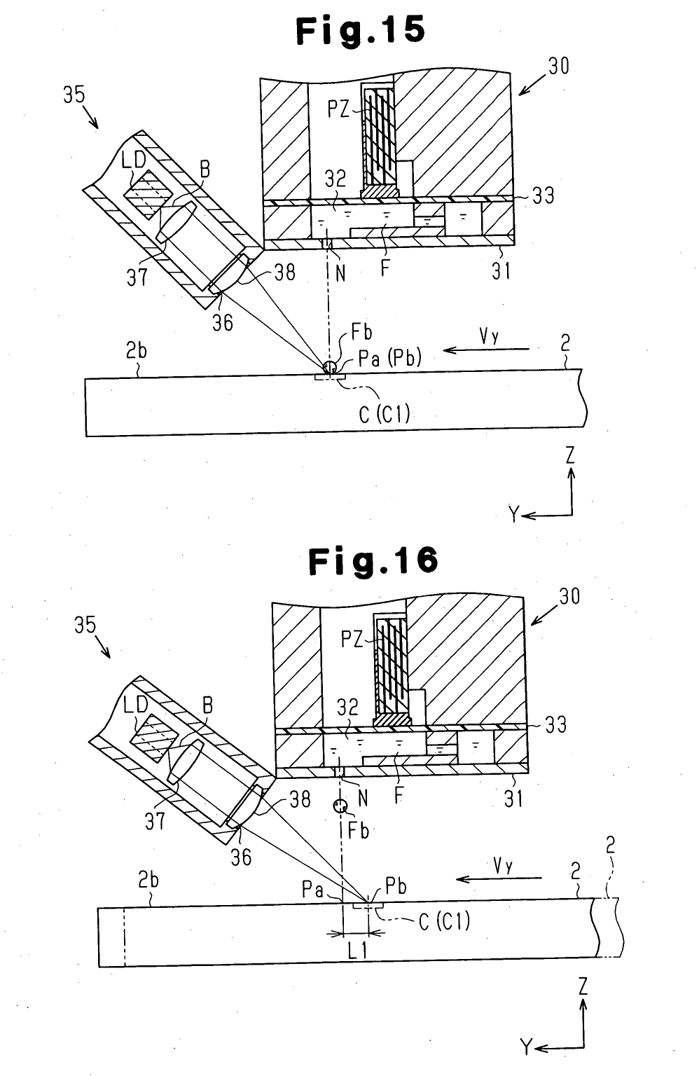

In the illustrated embodiment, the droplet receiving position Pa and the radiating position Pb are spaced from each other by the acceptable distance L. The laser beam B is radiated immediately after the acceptable duration Ta has elapsed since reception of the microdroplet Fb by the substrate 2. However, as shown in FIG. 15, the droplet receiving position Pa may coincide with the radiating position Pb. In this case, the radiation of the laser beam B is performed when or immediately before the microdroplet Fb is received by the substrate 2. In other words, the laser beam B is radiated at a relatively early stage. This enables each dot D to be formed with the outer diameter of the microdroplet Fb set to the maximum acceptable droplet diameter Rmax even if the ejection amount of microdroplet Fb is increased.

Alternatively, with the droplet receiving position Pa and the radiating position Pb coinciding with each other, referring to FIG. 15, the movement of the substrate stage 23 (the microdroplet Fb) may be stopped when the microdroplet Fb is received by the substrate 2. The radiation of the laser beam B is started before the acceptable duration Ta comes to an end. This prolongs the time for radiating the laser beam B since the substrate stage 23 is stopped at the radiating position Pb. The microdroplet Fb is thus reliably dried. Accordingly, each dot D is further reliably formed with the outer diameter of the microdroplet Fb set to the maximum acceptable droplet diameter Rmax.

In the illustrated embodiment, the radiating position Pb is located forward from the droplet receiving position Pa with respect to direction Y. However, as shown in FIG. 16, the radiating position Pb may be located rearward from the droplet receiving position Pa with respect to direction Y. In this case, the laser beam B is radiated onto the corresponding cell C (the corresponding black cell C1) before the cell C receives the microdroplet Fb. The cell C (the black cell C1) is thus heated before the microdroplet Fb reaches the cell C. Accordingly, each dot D is further reliably formed with the outer diameter of the microdroplet Fb set to the maximum acceptable droplet diameter Rmax.

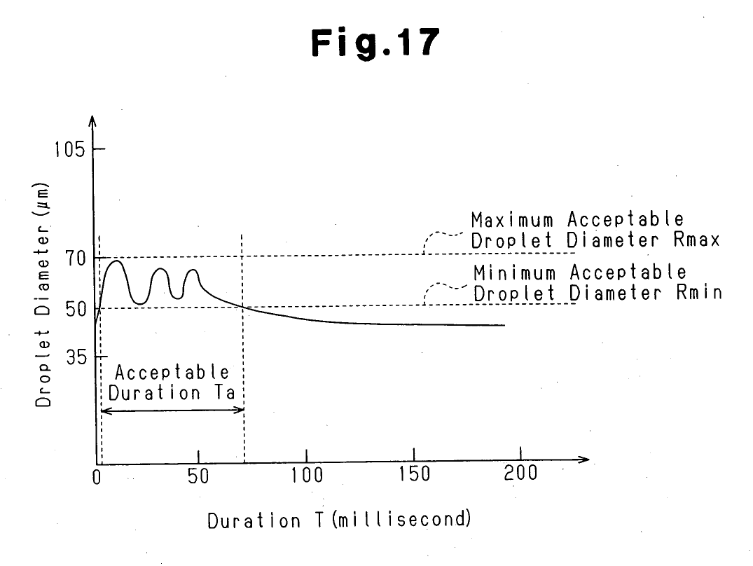

In the illustrated embodiment, the substrate 2 has the lyophilic property with respect to the microdroplet Fb. However, the substrate 2 may have liquid-repellency with respect to the microdroplets Fb. In this case, as shown in FIG. 17, the diameter of the microdroplet Fb fluctuates but increases from the original diameter corresponding to the state immediately after reception of the microdroplet Fb by the substrate 2. However, since the substrate 2 has the liquid repellency, the microdroplet Fb becomes fixed in a spherical shape and the diameter of the microdroplet Fb is reduced to the original diameter. Thus, the acceptable duration Ta is set in correspondence with the maximum acceptable droplet diameter Rmax and a minimum readable size of each dot D (a minimum acceptable droplet diameter Rmin). For example, referring to FIG. 17, if the diameter of the microdroplet Fb fluctuates in a range less than the maximum acceptable droplet diameter Rmax and the minimum acceptable droplet diameter Rmin is set to 50 micrometers, the acceptable duration Ta is set in such a manner that the eventual diameter of the microdroplet Fb corresponding to the reduced state becomes greater than or equal to 50 micrometers. In this manner, each dot D is further reliably formed with the outer diameter of the microdroplet Fb set to the maximum acceptable droplet diameter Rmax, regardless of the spherical shape of the microdroplet Fb.

In the illustrated embodiment, each dot D is formed by radiating the laser beam B onto the microdroplet Fb that is spread wet on the substrate 2 in a semispherical shape. However, instead of this, the microdroplet Fb may be ejected onto a porous substrate (for example, a ceramic multi-layer substrate or a green sheet). The laser beam B is thus radiated onto the microdroplet Fb permeating through the substrate, thereby forming a pattern of metal wiring. In this case, the acceptable duration Ta is set to the time for which pattern forming material such as metal particles dispersed in the microdroplet Fb can be maintained on the porous substrate. In this manner, regardless of permeation of the microdroplet Fb through the substrate, metal wiring of a desired size can be provided reliably.

In the illustrated embodiment, the open-close signal GS2 is generated in response to the ejection control signal SI. However, instead of this, the open-close signal GS2 may be produced in response to the detection signal of the substrate detector 53 or the y-axis motor rotation detector 55a. In other words, the open-close signal GS2 may be generated at any suitable timing, as long as radiation of the laser beam B is enabled immediately after the acceptable duration Ta has elapsed since reception of the microdroplet Fb by the substrate 2.

In the illustrate embodiment, the radiating position Pb for the laser beam B is defined as a fixed position on the substrate 2. However, instead of this, an optical scanning system such as a polygon mirror may be provided in the laser head 35 for moving the radiating position Pb along the movement direction (the longitudinal direction) of the microdroplet Fb. This prolongs the radiation time of the laser beam B by an amount corresponding to the distance for which the radiating position Pb is moved in correspondence with the movement of the microdroplet Fb. The microdroplet Fb is thus reliably dried. Accordingly, each dot D is further reliably formed with the outer diameter of the microdroplet Fb set to the maximum acceptable droplet diameter Rmax.

In the illustrated embodiment, the laser radiation means may be formed by, for example, a CO₂ laser or a YAG laser. That is, any suitable laser may be employed as long as the laser radiates the laser beam B having a wavelength that permits the microdroplet Fb to dry.

In the illustrated embodiment, the semiconductor lasers LD are provided by the quantity corresponding to the quantity of the nozzles N. However, the laser beam B may be radiated by a single laser source and divided into sixteen rays using a dividing element such as a diffracting element.

In the illustrated embodiment, radiation of the laser beam B is controlled through operation of the switch elements Sb1 to Sb16 corresponding to the semiconductor lasers LD. However, such radiation may be controlled using a shutter provided in the optical path of the laser beam B. More specifically, such controlling is performed by adjusting operational timings of the shutter, which can be selectively opened and closed.

In the illustrated embodiment, the shape of each dot D as viewed from above may be modified to, for example, an oval shape or a linear shape defining part of a bar code.

The present invention may be applied to formation of a pattern in, for example, an insulating film or metal wiring. Also in these cases, the pattern can be formed to a desired size.

In the illustrated embodiment, the substrate may be formed by, for example, a silicone substrate, a flexible substrate, or a metal substrate.

In the illustrated embodiment, the pressure chamber (the cavity 32) may be pressurized by different pressurizing means other than the piezoelectric elements PZ. Also in this case, the pattern can be formed to a desired size.

In the illustrated embodiment, the liquid ejection apparatus 20 may be formed by a liquid ejection apparatus that forms the insulating film or the metal wiring. Also in this case, the size of the pattern of, for example, the wiring can be adjusted in a desired manner.

In the illustrated embodiment, the dots D (the identification code 10) may be formed in a display module of an organic electroluminescence display, instead of the liquid crystal display module 1. Further, the dots D may be formed in a display module of a field effect device (FED or SED) that causes a fluorescent substance to emit light using electrons emitted from a flat electron emission element.

The present examples and embodiments are to be considered as illustrative and not restrictive and the invention is not to be limited to the details given herein, but may be modified within the scope and equivalence of the appended claims.

1. A method for forming a dot by ejecting a liquid droplet onto a dot forming position defined on a substrate and drying the droplet that has reached the dot forming position;
wherein a laser beam for drying the droplet is radiated onto the dot forming position.

2. The method according to claim 1, wherein the laser beam is radiated onto the dot forming position before the outer diameter of the droplet that has reached the dot forming position becomes greater than a predetermined value.

3. The method according to claim 1, wherein the laser beam is radiated onto the dot forming position before the outer diameter of the droplet that has reached the dot forming position becomes smaller than a predetermined value.

4. The method according to claim 1, wherein the laser beam is radiated onto the dot forming position while a dot forming material of the droplet that has reached the dot forming position is maintained on the substrate.

5. The method according to claim 1, wherein the laser beam is radiated onto the dot forming position before 100 milliseconds elapses after the droplet has reached the dot forming position.

6. The method according to claim 1, wherein the laser beam is radiated onto the dot forming position before the droplet reaches the dot forming position.

7. The method according to claim 1, wherein the droplet is ejected by an inkjet method.

8. The method according to claim 1, wherein the dot is one of a plurality of dots that form a code pattern representing product information regarding a liquid crystal display module.

9. A method for forming an identification code pattern with a plurality of dots in a code formation area on a surface of a substrate, wherein data cells are formed by dividing the code formation area, wherein the dots are formed in selected ones of the data cells by ejecting liquid droplets containing a dot forming material onto the selected data cells and drying the droplets in the selected data cells;
wherein a laser beams for drying the droplets are radiated onto the code formation area.

10. The method according to claim 9, wherein the laser beams are radiated onto the code formation area before the outer diameter of each droplet that has reached the code formation area becomes greater than a predetermined value.

11. The method according to claim 9, wherein the laser beams are radiated onto the code formation area before the outer diameter of each droplet that has reached the code formation area becomes smaller than a predetermined value.

12. The method according to claim 9, wherein the laser beams are radiated onto the code formation area while the dot forming material of each droplet that has reached the code formation area is maintained on the substrate.

13. The method according to claim 9, wherein the laser beams are radiated onto the code formation area before 100 milliseconds elapses after the droplets have reached the code formation area.

14. The method according to claim 9, wherein the laser beams are radiated onto the code formation area before the droplets reach the code formation area.

15. The method according to claim 9, wherein the droplets are ejected by an inkjet method.

16. The method according to claim 9, wherein the code pattern represents product information regarding a liquid crystal display module.

17. A liquid ejection apparatus having pressurization means that pressurizes liquid retained in a pressure chamber and an ejection port through which a droplet of the liquid is ejected onto a dot forming position defined on a substrate through pressurization of the pressurization means, the apparatus comprising:
laser radiation means that radiates a laser beam for drying the droplet that has been received by the substrate;
radiation control means, wherein, when the ejected droplet is received by the substrate, the radiation control means operates the laser radiation means to radiate the laser beam onto the dot forming position when an outer diameter of the ejected droplet reaches a predetermined outer diameter; and
a controller that controls operation of the radiation control means.

18. The liquid ejection apparatus according to claim 17, wherein the radiation control means operates the laser radiation means when the outer diameter of the ejected droplet reaches the predetermined outer diameter.

19. The liquid ejection apparatus method according to claim 18, wherein the radiation control means operates the laser radiation means in correspondence with the pressurization of the pressurization means.

20. The liquid ejection apparatus according to claim 17,
wherein the radiation control means has a substrate stage on which the substrate is mounted, and
wherein the controller operates the substrate stage in such a manner that, when an outer diameter of the droplet reaches a predetermined outer diameter, the dot forming position corresponds to a radiating position at which the laser beam is radiated onto the substrate.
